(19) United States
(12) Patent Application Publication
(10) Pub. No.: US 2006/0079194 A1
(43) Pub. Date: Apr. 13, 2006

(54) Communications receiver method and apparatus

(76) Inventors: Tobias Tired, Lund (SE); Sven Mattisson, Bjarred (SE)

Correspondence Address: COATS & BENNETT, PLLC, P O BOX 5, RALEIGH, NC, 27602, US

(21) Appl. No.: 11/274,446

(22) Filed: Nov. 15, 2005

Related U.S. Application Data
(63) Continuation-in-part of application No. 10/746,330, filed on Dec. 23, 2003.

(51) Int. Cl. H04B 1/06; H04B 1/10; H04B 1/26

(52) U.S. Cl. 455/283; 455/313; 455/240.1

(57) ABSTRACT

A radiofrequency (RF) receiver circuit and method offer one or more performance improvements, such as an increased input compression point through better out-of-band interference suppression. In one example, an RF receiver circuit includes a low-noise amplifier (LNA) circuit and a mixer. The mixer output signal serves as negative feedback to the LNA circuit for improved compression point performance at interferer frequencies in or out of band with respect to a frequency of interest. Compression point performance is further improved for interferer signal components away from the frequency of interest by including at least one frequency-dependent circuit in the LNA circuit that is configured to reduce amplifier gain for such frequencies. The frequency-dependent circuit(s) may be tunable for different frequencies of interest. Additional improvements may be obtained by including a broadband input matching circuit and/or by including active mixer loads to increase the voltage conversion gain of the RF receiver circuit.

### RELATED APPLICATIONS

This application claims priority under 35 U.S.C. § 120 as a continuation-in-part of U.S. application Ser. No. 10/746,330, filed on 23 Dec. 2003 and entitled “Mixer with Feedback.” The priority application is expressly incorporated herein by reference.

### BACKGROUND OF THE INVENTION

The present invention generally relates to wireless communications, and particularly relates to radiofrequency (RF) receivers.

RF receivers must exhibit required sensitivities in the presence of potentially significant interference from unwanted signals. Unwanted signals may be received over the air or may originate locally. For example, mixers used in the down-conversion function of typical RF receivers use square-wave oscillator signals exhibiting large signal components at the third harmonic of the local oscillator frequency. Interference at the third harmonic thus will be down-converted unless attenuated or otherwise rejected within the receiver signal chain.

As a general proposition, inadequately suppressed interference within the receiver chain limits the receiver circuit's compression point of the receiver circuit. The “1 dB” compression point of an amplifier circuit is the operating point at which the amplifier's gain response is reduced by 1 dB. Unsuppressed interference within the receiver signal chain can desensitize the receiver relative to the wanted input signal such that the 1 dB compression point is reached at lower wanted signal power.

The co-pending U.S. patent application from which the instant application claims priority details methods and apparatus that yield compression point improvements. However, further opportunities remain for extending compression point improvements and, among other things, improving receiver noise figure and voltage conversion gain.

### SUMMARY OF THE INVENTION

According to the methods and apparatus taught herein, a radiofrequency receiver circuit comprises a low-noise amplifier circuit, a mixer circuit, and a feedback circuit. The low-noise amplifier circuit is configured to generate an amplified output signal responsive to a radiofrequency input signal and includes at least one frequency-dependent circuit configured to decrease amplifier gain at frequencies away from a frequency of interest. In turn, the mixer circuit is configured to generate a mixer output signal responsive to the amplified output signal and one or more local oscillator signals, and the feedback circuit is configured to couple the mixer output signal to the low-noise amplifier circuit as a negative feedback signal.

In general, the negative feedback improves the compression point performance of the radiofrequency receiver circuit by decreasing amplifier gain, even where interferer signal frequencies are in-band with the frequency of interest. Further compression point improvements are gained for interferer signal frequencies that are away from the frequency of interest, based on configuring the at least one frequency-dependent circuit to decrease amplifier gain for such frequencies. For example, the at least one frequency-dependent circuit may comprise a resonant collector load circuit for an input stage transistor included in the low-noise amplifier circuit. With this configuration, the resonant collector load circuit can be configured to have decreasing impedance with increasing distance from the frequency of interest. In one embodiment, the resonant, collector load circuit has reduced or minimal impedance at a harmonic of the local oscillator signal frequency to achieve suppression of interferer signal components at that harmonic.

The resonant collector load circuit may comprise a parallel resistor-inductor-capacitor circuit, a notch-filter circuit, or some combination of the two. In general, its frequency response can be tailored to yield desired frequency-selective gain reductions. Moreover, the resonant collector load circuit may comprise an adjustable circuit having a frequency response that is changeable, responsive to a frequency control signal for example. Such a configuration enables the radiofrequency receiver circuit to be adjusted for operation at different frequencies of interest, which complements its use in a wireless communication device intended to operate at different radio frequencies, for example.

Additionally, or alternatively, the at least one frequency-dependent circuit may comprise a resonant input signal filter circuit for the input stage transistor of the low-noise amplifier circuit. This configuration achieves amplifier gain reduction for frequencies away from the frequency of interest by attenuating such frequencies at the amplifier input. As with the resonant collector load circuit, the resonant input signal filter circuit can be configured as a notch filter, and it should be understood that the notch frequency can be set according to a desired suppression frequency—e.g., a harmonic of the local oscillator signal frequency. Further, the resonant input signal filter circuit can be an adjustable circuit whose frequency response is adjustable for operating the radiofrequency receiver circuit at different frequencies of interest. If the resonant input signal filter circuit is used in combination with a resonant collector load circuit, both circuits may be made adjustable, such that they can be tuned for interferer frequency suppression at selectable frequencies of interest.

The radiofrequency receiver circuit may further include a broadband input signal matching circuit configured to provide input matching across a range of frequencies of interest, and may include an active mixer load to increase its voltage conversion gain. Regardless of these and other details, the radiofrequency circuit may be embodied in a wireless communication device. By way of non-limiting examples, the wireless communication device may comprise a pager, a palmtop or laptop computer, or a mobile station (handset) for use in a cellular communication network.

As such, at least one embodiment of the radiofrequency receiver circuit includes a tunable resonant frequency load that is switchable between two or more receive frequency bands of interest, e.g., the GSM850, GSM900, and DCS1800 cellular communication bands. Tuning of the one or more frequency-dependent circuits may be achieved by configuring it (or them) to have one or more switched capacitors (or other switched impedance elements) for changing the frequency response.

Of course, the present invention is not limited to the above features and advantages. Those skilled in the art will recognize additional features and advantages upon reading the following detailed description, and upon viewing the accompanying drawings.

### BRIEF DESCRIPTION OF THE DRAWINGS

FIG. 1 is a simplified block diagram of a receiver including one embodiment of a receiver circuit according to the methods and apparatus taught herein.

FIG. 2 is a simplified schematic diagram for one embodiment of the receiver circuit of FIG. 1.

FIG. 3 is a schematic diagram of another embodiment of an input matching circuit for the low-noise amplifier circuit of FIG. 2.

FIG. 4 is a schematic diagram of an adjustable resonant collector load circuit that may be used in the low-noise amplifier circuit of FIG. 2, for example.

FIG. 5 is a simplified schematic diagram for another embodiment of the receiver circuit of FIG. 1.

FIG. 6 is a schematic diagram of an adjustable resonant collector load circuit that may be used in the low-noise amplifier circuit of FIG. 5, for example.

FIG. 7 is a simplified schematic diagram for another embodiment of the receiver circuit of FIG. 1.

FIG. 8 is a schematic diagram of an adjustable resonant input signal filter circuit that may be used, for example, in the low-noise amplifier circuit of FIG. 7.

FIG. 9 is a simplified block diagram of a wireless communication device, such as a cellular radiotelephone, incorporating an embodiment of a receiver circuit according to the methods and apparatus taught herein.

### DETAILED DESCRIPTION OF THE INVENTION

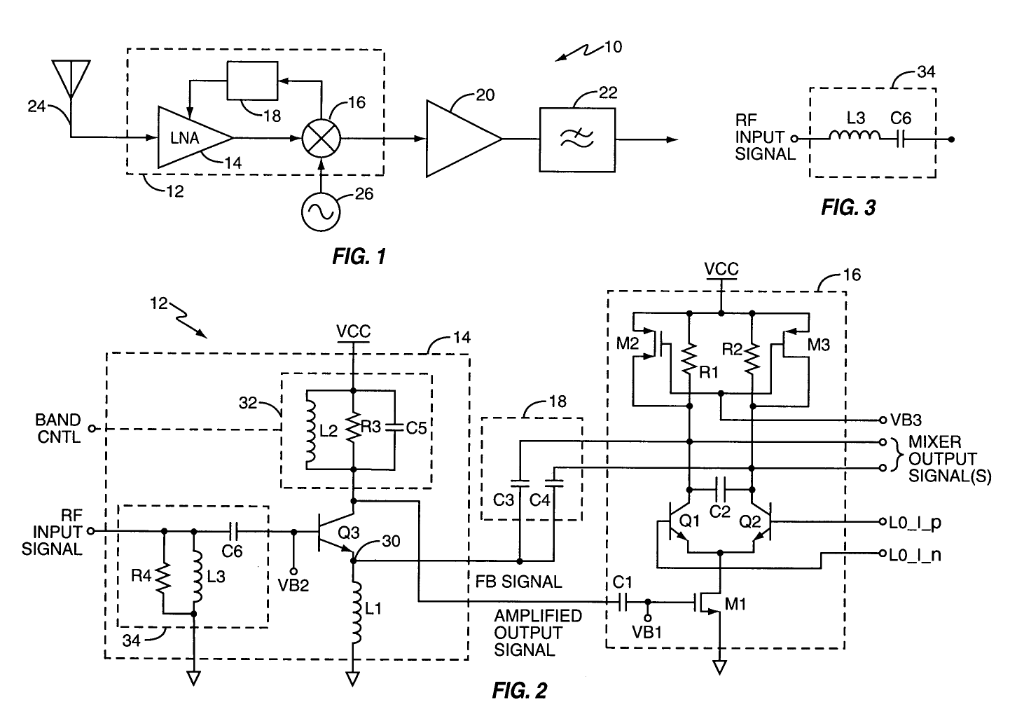

FIG. 1 illustrates a radiofrequency (RF) receiver 10, including a receiver circuit 12 that comprises a low-noise amplifier (LNA) circuit 14, a mixer circuit 16, and a feedback circuit 18. The receiver 10 further includes a mixer output amplifier 20 and a (low-pass) filter 22, and includes (or is associated with) an antenna 24 and a local oscillator 26.

In operation, the LNA circuit 14 generates an amplified output signal responsive to an antenna-received RF input signal applied to an amplifier input of the LNA circuit 14. In turn, the mixer circuit 16 generates a mixer output signal responsive to the amplified output signal and one or more local oscillator signals from the local oscillator 26. The mixer output amplifier 20 amplifies the mixer output signal, which, in at least one embodiment, comprises a down-converted baseband signal obtained by frequency-shifting the amplified output signal down to baseband from a given radio carrier frequency.

The filter 22 filters the baseband signal from the mixer output amplifier 20 and baseband processing is then carried out on the filtered signal to recover transmitted information carried therein. Such processing may comprise digitization into in-phase (I) and quadrature (Q) digital sample streams, e.g., 4-bit or 6-bit sample values corresponding to the time-varying baseband signal output from the filter 22. A baseband processor (not shown), e.g., a Digital Signal Processor (DSP) or other microprocessor, then processes the digitized samples as needed or desired.

FIG. 2 offers circuit details for one embodiment of the receiver circuit 12 and provides a basis for discussing selected aspects of its operation. The illustrated embodiment of the mixer circuit 16 comprises a transconductance transistor M1 driven by the amplified output signal from the LNA circuit 14 through a capacitor C1, mixer core transistors Q1 and Q2 disposed on the drain of M1 and configured to be driven by complementary local oscillator input signals (LO_I_p and LO_I_n), a capacitor C2 coupling the collectors of Q1/Q2 together, and a mixer load circuit comprising transistors M2 and M3 and resistors R1 and R2. (Note that the illustration is simplified for discussion. For example, assuming quadrature signal generation, the mixer circuit 16 includes illustrated circuitry for generating the in-phase (I) components of the mixer output signal and duplicate circuitry—not shown—would be included to generate the quadrature (Q) components.)

The illustrated embodiment of the feedback circuit 18 comprises coupling capacitors C3 and C4, which couple the mixer output signal back to the LNA circuit 14 as a feedback signal. The LNA circuit 14 comprises an input stage transistor Q3 having an emitter degeneration connection 30 that is coupled to signal ground through an inductor L1 and that is configured to receive the feedback signal from the feedback circuit 18. The input stage transistor Q3 further has a frequency-dependent load 32 and an LNA input matching circuit 34. In the illustrated embodiment of the receiver circuit 12 the frequency-dependent load circuit 32 comprises a resonant collector load circuit implemented as a parallel resistor-inductor-capacitor (RLC) circuit formed from an inductor L2, a resistor R3, and a capacitor C5. The LNA input matching circuit 34 comprises an input capacitor C6 coupling an RF signal input to the base of the transistor Q3, and an inductor L3 and a resistor R4 in a shunt configuration, coupling the RF signal input to signal ground.

In an advantageous configuration, the LNA input matching circuit 34 provides broadband or selective input impedance matching for a given range of receiver frequency bands of interest. For example, the LNA input matching circuit 34 may be configured to provide 50 Ohm input matching for GSM 850, GSM900, DCS1800 and PCS 1900 frequency bands. With good matching, the return loss can be below −10 dB for input frequencies between 718 MHz and 2031 MHz. Of course, the illustrated matching circuit embodiment represents one example for broadband impedance matching based on connecting the resistor R4 between the input of the LNA circuit 14 to signal ground. Different circuit configurations may be used for different applications. For example, FIG. 3 depicts another embodiment of the matching circuit 34 for narrow band impedance matching, such as in single band applications, wherein the inductor L3 and the capacitor C6 are arranged in a series configuration at the RF signal input.

Turning from input matching to other aspects of operation for the receiver circuit 12, it should be noted that the load of the mixer circuit 16 comprises passive elements (resistors R1 and R2) and active elements (transistors M2 and M3). That is, R1 acts as a passive load for the collector of Q1 and R2 acts as a passive load for the collector of Q2. The voltage drop from the supply voltage VCC across the load resistors R1 and R2 dynamically changes responsive to the amplified output signal from the LNA circuit 14, as driven through C1 into M1, and responsive to the local oscillator signals LO_I_p and LO_I_n, as used to drive the bases of Q1 and Q2.

To improve the voltage conversion gain of the receiver circuit 12, transistors M2 and M3 in the mixer circuit 16 are configured as “active loads.” More particularly, M2 operates in parallel with the load resistor R1 and M3 operates in parallel with the load resistor R2. In operation, these active elements (M2 and M3) increase the voltage conversion gain by acting as current sources that bypass the DC-current from the load resistors R1 and R2.

Absent the inclusion of the active load elements, the load resistors R1 and R2 generally must be configured to have lower resistance values because the voltage drop across them for higher amplitudes of the amplified output signal from the LNA circuit 14 would otherwise forward bias the base-collector junctions of the mixer core transistors Q1 and Q2. Thus, the use of an active mixer load, as embodied in the transistors M1 and M2 positioned in parallel with the resistors R2 and R3, improves the performance of the receiver circuit 12 by increasing its voltage conversion gain with negligible degradation of its noise performance.

The inclusion of the feedback circuit 18 offers further performance improvements for the receiver circuit 12 by feeding back the mixer circuit's output signal(s) to the LNA circuit 14 as a negative feedback signal. Doing so improves the compression point performance of the receiver circuit 12.

This feedback-based approach to improve compression point performance offers advantages over other approaches. For example, the compression point of the overall receiver circuit 12 is limited by clipping in the drain current of the transconductance transistor M1 in the mixer circuit 16. That is, the presence of high-power interferers in the amplified output signal applied to the gate of M1 results in large gate-to-source voltages at M1 and the resultant nonlinearity in M1's operation stands as a predominant source of distortion. Thus, increasing M1's bias current would reduce such clipping and thereby improve compression point interference, but doing so would degrade the noise figure of the receiver circuit 12. Such degradation would arise because the increased noise of M1 due to increasing its bias current would appear in the mixer output signal and, therefore, would appear in the feedback signal coupled back to the LNA circuit 14.

In looking at the feedback-based approach in more detail, one sees that the emitter of the input stage transistor Q3 is coupled to an emitter degeneration connection 30, which is coupled to signal ground through the emitter degeneration inductor L1. With this configuration, the feedback signal applied to the emitter degeneration connection 30 by the feedback circuit 18 is derived from the mixer output signal. As taught in the '030 patent application from which the instant application claims priority, applying the feedback signal to the emitter degeneration connection 30 in this manner improves compression point performance by generating a feedback voltage across the inductor L1 that operates as negative feedback for the input stage transistor Q3.

Using the inductor L1 for emitter degeneration rather than a resistor improves the noise performance of the receiver circuit 12. Moreover, this use of L1 for emitter degeneration imposes relatively low “Q” requirements (e.g., Q=6 at 940 MHz), which makes practical the incorporation of L1 coil within an integrated circuit implementation of the receiver circuit 12.

The use of the mixer output signal as negative feedback to the LNA circuit 14 maintains the receiver circuit's compression point (below 0 dBm) for high-power interferer signal components that are at or near the receiver frequency band of interest. Further compression point performance improvement can be gained for interferer frequencies that are away from the receiver frequency band of interest. That is, the amplifier gain of the receiver circuit 12 can be configured to decrease with increasing frequency distance from the frequency of interest, meaning that amplification by the LNA circuit 14 of out-of-band interferer signal components can be significantly suppressed by including one or more appropriately configured frequency-dependent circuits in the LNA circuit 14.

This approach means that the loop gain for the wanted signal is not altered, while the attenuation of interferer signal components at frequencies outside the receiver frequency band of interest secures a high compression point (above 0 dBm). More particularly, the LNA circuit 14 can be configured to exhibit reduced or minimum amplifier gain at a harmonic of the local oscillator signal frequency. For example, referring back to the point made earlier herein regarding harmonic interference caused by the use of square-wave oscillator signals, the at least one frequency-dependent circuit included in the LNA circuit 14 can be tuned to decrease amplifier gain for the third harmonic of the local oscillator frequency, i.e., 3×f_{LO}. For reference, the third overtone for the center frequency of the GSM900 band is at 2827.5 MHz and is at 2644.5 MHz for the GSM850 band. Those skilled in the art will appreciate that the frequency-dependent load circuit 32 can be tuned to suppress third overtones of any frequency band of interest, such as for the DCS1800 and PCS1900 bands.

To accomplish frequency-selective loop gain, the frequency-dependent load circuit 32 may be implemented as a resonant collector load circuit for the input stage transistor Q3 as shown in FIG. 2. With this configuration, the resonant frequency of the frequency-dependent load circuit 32 is determined by the values of the RLC elements R3, L2, and C5. Any one or more of those values can be adjusted such that the frequency response is changeable for operating the radiofrequency receiver circuit at different frequencies of interest. Thus, the receiver circuit 12 can be configured, for example, to exhibit a minimum amplifier gain at an adjustable range of frequencies, meaning that its operation can be optimized for different frequencies of interest.

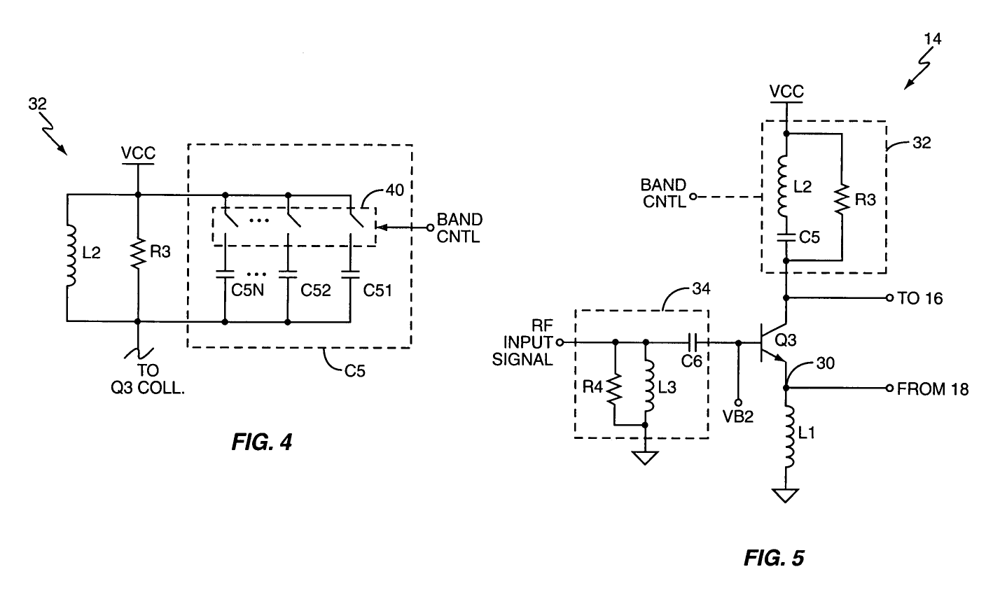

For example, FIG. 2 illustrates an optional BAND_CNTL signal as an input to the frequency-dependent load circuit 32. FIG. 4 illustrates one embodiment of the frequency-dependent load circuit 32 in which its resonant frequency changes responsive to the BAND_CNTL signal. More particularly, the frequency-dependent load circuit 32 is configured as an adjustable resonant load circuit wherein the capacitor C5 is implemented as an array of capacitors, denoted as C51, C52, . . . , C5N. These capacitors are selectively coupled into the parallel RLC circuit via switches 40. By way of non-limiting examples, the switches 40 may comprise transistor-based switches or micro-electromechanical switches (MEMs).

With this configuration, the effective capacitance of the capacitor C5 changes as a function of the combination of switched capacitors C51-C5N that are connected and disconnected via the switches 40. Therefore, the resonant frequency of the frequency-dependent load circuit 32 is selectable according to the BAND_CNTL signal applied to the switches 40. Those skilled in the art will appreciate that the switch selection signal may be analog or digital and that such details are not limiting. As non-limiting examples, the band control signal may comprise two or more discrete signal lines, with each line coupled to a corresponding one of the switches 40, or the band control signal may comprise an n-bit digital signal that is translated into specific switch selection combinations.

Further, those skilled in the art will recognize that changing the capacitance of C5, changing the inductance of L2, changing the resistance of R3, or changing two or more of these impedances in combination all may be used to change the resonant frequency of the frequency-dependent load circuit 32. In cellular communication embodiments of the receiver circuit 12, for example, it may be desirable to configure the frequency-dependent load circuit 32 for resonant frequencies in the GSM850, GSM900, and DCS1800 frequency bands, to support tri-mode operations.

The quality “Q” for resonance of the frequency-dependent load circuit 32 should be reasonably high. As is understood by those skilled in the art, the Q value of a resonant circuit may be defined as its resonance frequency divided by its resonance bandwidth. Viewed from another perspective, the Q value is defined as the ratio of energy stored to energy dissipated at resonance. In general, a high Q value corresponds to sharp frequency response roll-offs on either side of the resonant frequency. In any case, for the circuit at hand, a Q value of fifteen or higher, for example, provides meaningful compression point improvement through suppression of out-of-band interferers in the amplified output signal. Such a Q value makes practicable full or partial implementation of the receiver circuit 12 as an integrated circuit device.

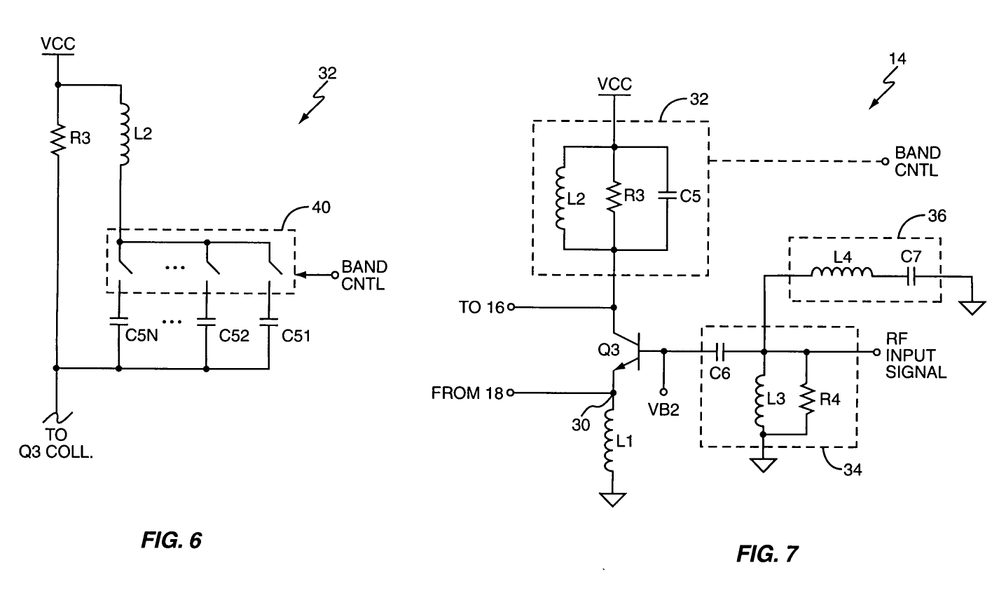

Of course, the frequency-dependent load circuit 32 is not limited to RLC configurations. For example, FIG. 5 illustrates the LNA circuit 14, wherein its frequency-dependent load circuit 32 is configured as a notch-filter circuit based on the resistor R3 being placed in parallel with the series combination of the inductor L2 and the capacitor C5. The notch filter configuration of the frequency-dependent load circuit can be configured such that the effective collector load for the input stage transistor Q3 is very small at 3×f_{LO}. The conversion gain for an interferer at 3×f_{LO} will therefore be greatly reduced. As with the adjustable configuration shown in FIG. 4, the notch-filter implementation of the frequency-dependent load circuit 32 may be made adjustable as is shown in FIG. 6. The notch filter configuration can be tuned to different notch frequencies, e.g., to different 3×f_{Lo} frequencies, by switching in different combinations of capacitors.

Further, the frequency-dependent load circuit 32 can be implemented using a combination of circuit topologies. For example, its frequency response may be made more complex, or its performance improved, by incorporating a combination of RLC resonant circuits and notch-filter circuits. In general, it should be understood that the frequency-dependent load circuit 32 can be configured as needed for the desired frequency response characteristics, e.g., it can be configured to have different filter frequencies and different roll-off characteristics as needed or desired.

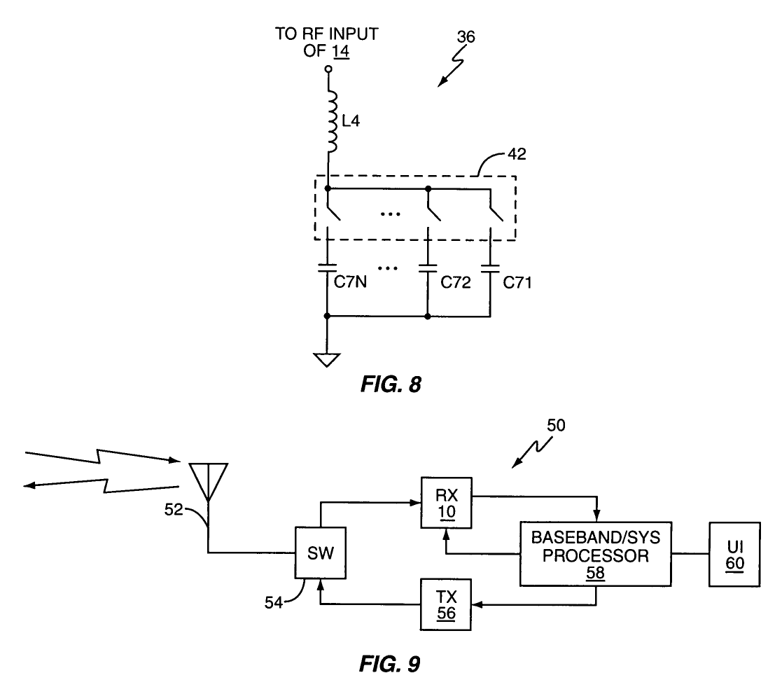

Still further performance improvements may be attained for the receiver circuit 12 by using notch filtering at the LNA circuit input. That is, the LNA circuit 14 can be configured to have a resonant input signal filter circuit 36 as shown in FIG. 7 as an addition to the resonant collector load circuit 32, or as an alternative to it. In the illustrated embodiment, the resonant input signal filter circuit 36 is configured as a notch filter comprising an inductor L4 in series with a capacitor C7. More particularly, L4 is coupled at one end to the input of the LNA circuit 14 and at the other end to C7, which in turn is coupled to signal ground. The input notch filter 36 can be configured for interferer suppression, e.g., it can be tuned to suppress third harmonics of the local oscillator frequency. Of course, the input filter circuit 36 can be adjustable, e.g., using a switched capacitor array as shown in FIG. 8, so that its attenuation frequency can be tuned. If the LNA circuit 14 includes both the collector load circuit 32 and the input filter circuit 34, they may both be made adjustable in tandem, such that the LNA circuit 14 can be tuned for operation at different frequencies of interest.

With the above possibilities for frequency adjustment in mind, the receiver circuit 12 finds advantageous application in a variety of wireless communication device applications. That is, the configuration(s) taught herein support a flexible method of improving performance of the radio receiver circuit 12 based on including at least one frequency-dependent circuit in the low-noise amplifier 14 circuit to decrease amplifier gain at frequencies away from a frequency of interest, and feeding back the mixer output signal to the low-noise amplifier circuit as a negative feedback signal.

The above method and supporting apparatus may be embodied in a wireless communication device, such as the wireless communication device 50 illustrated in FIG. 9. It should be understood that the device 50 may be, for example, a pager, mobile handset, PDA, handheld computer, or other type of communication device or system. In the illustrated embodiment, the device 50 comprises one or more antennas 52 and an associated switch (and/or duplexer) circuit 54 that is coupled to a transmitter 56 and an embodiment of the receiver 10 as introduced in FIG. 1. The device 50 further comprises a baseband/system processor 58 that actually may comprise one or more microprocessors or other processing circuits, and a user interface 60.

The receiver 10 includes the receiver circuit 12 according to any of the embodiments described herein (or variations thereof. In particular, where the device 50 is a cellular radiotelephone or multi-network pager, it may be advantageous to configure the receiver circuit 12 for multi-band operation in accordance with the teachings of FIGS. 4, 6, or 8, for example.

To that end, the baseband/system processor 58 may include hardware and/or software-based logic to generate frequency (selection) control signals for the receiver circuit 12. Accordingly, the baseband/system processor 58 may assert one or more output signals (physical or logical) that change the tuning of the receiver circuit 12 for operation at a selected frequency of interest. More particularly, for a given frequency of interest, the frequency control signals can be configured to adjust the frequency responses of the resonant collector load circuit 32 and/or the resonant input signal filter circuit 36 described earlier herein to decrease the gain of the low-noise amplifier circuit 14 within a frequency range associated with the selected frequency of interest. Such tuning may be carried out, for example, according to what networks are currently available or preferred.

With the ability to adjust the frequency response of the receiver circuit's frequency-dependent load circuit 32 and/or its input matching/filtering circuits 34/36, the device 50 can use one receiver to cover multiple frequency bands, such as the GSM850, GSM900, DCS1800 and PCS1900 frequency bands. Configuration the LNA input matching circuit 34 for broadband performance helps insure that the receiver circuit 12 offers good performance across more than a frequency octave, spanning from the 869 MHz GSM850 band to the 1990 MHz PCS1900 band.

Regardless of whether such broadband operation is desired, the receiver circuit 12 offers good compression point performance for in-band interferers by virtue of mixer output feedback to the LNA circuit 14 and even better compression point performance for out-of-band interferers by virtue of its inclusion of one or more frequency-dependent circuits that reduce amplifier gain for the LNA circuit 14 at frequencies away from a receiver frequency band of interest. With these broad points in mind, it should be understood that the present invention is not limited by the foregoing description, nor is it limited by the accompanying drawings. Instead, the present invention is limited only by the following claims, and their legal equivalents.

What is claimed is:

1. A radiofrequency receiver circuit comprising:
a low-noise amplifier circuit configured to generate an amplified output signal responsive to a radiofrequency input signal, said low-noise amplifier circuit including at least one frequency-dependent circuit configured to decrease amplifier gain at frequencies away from a frequency of interest;
a mixer circuit configured to generate a mixer output signal responsive to the amplified output signal and one or more local oscillator signals; and
a feedback circuit configured to couple the mixer output signal to the low-noise amplifier circuit as a negative feedback signal.

2. The radiofrequency receiver circuit of claim 1, wherein the at least one frequency-dependent circuit comprises a resonant collector load circuit for an input stage transistor of the low-noise amplifier circuit.

3. The radiofrequency receiver circuit of claim 2, wherein the frequency of interest is a local oscillator frequency of the one or more local oscillator signals, and wherein the resonant collector load circuit is configured to have reduced impedance at a harmonic of the local oscillator frequency.

4. The radiofrequency receiver circuit of claim 2, wherein the resonant collector load circuit is configured to have a frequency response that minimizes collector load at a desired distance away from the frequency of interest.

5. The radiofrequency receiver circuit of claim 2, wherein the resonant collector load circuit comprises an adjustable circuit having a frequency response that is changeable responsive to a frequency control signal, such that the radiofrequency receiver circuit is configurable for operation at different frequencies of interest.

6. The radiofrequency receiver circuit of claim 2, wherein the resonant collector load circuit comprises at least one of a notch-filter circuit and a parallel resistor-inductor-capacitor circuit.

7. The radiofrequency receiver circuit of claim 2, wherein the at least one frequency-dependent circuit further comprises a resonant input signal filter circuit for the input stage transistor.

8. The radiofrequency receiver circuit of claim 7, wherein the resonant collector load circuit and the resonant input signal filter circuit comprise adjustable circuits whose frequency responses can be adjusted for operating the radiofrequency receiver circuit at different frequencies of interest.

9. The radiofrequency receiver circuit of claim 1, further comprising a broadband input signal matching circuit configured to provide input matching across a range of frequencies of interest.

10. The radiofrequency receiver circuit of claim 1, wherein the mixer circuit includes an active mixer load to increase a voltage conversion gain of the RF receiver circuit.

11. The radiofrequency receiver circuit of claim 1, wherein the low-noise amplifier circuit includes an input stage transistor having an emitter degeneration connection configured to receive the feedback signal as negative feedback for the input stage transistor.

12. The radiofrequency receiver circuit of claim 11, wherein the emitter degeneration connection comprises an emitter output of the input stage transistor, and wherein the emitter output of the input stage transistor is coupled to signal ground through an inductive element.

13. A method of improving the performance of a radiofrequency receiver circuit comprising a low-noise amplifier circuit generating an amplified output signal responsive to an input signal and a mixer circuit generating a mixer output signal responsive to the amplified output signal and one or more local oscillator signals, the method comprising:
including at least one frequency-dependent circuit in the low-noise amplifier circuit to decrease amplifier gain at frequencies away from a frequency of interest; and
feeding back the mixer output signal to the low-noise amplifier circuit as a negative feedback signal.

14. The method of claim 13, wherein including the at least one frequency-dependent circuit comprises including a resonant collector load circuit for an input stage transistor of the low-noise amplifier circuit, wherein the resonant collector load circuit is configured to have decreasing impedance at increasing distance from the frequency of interest.

15. The method of claim 14, wherein the frequency of interest is a local oscillator frequency of the one or more local oscillator signals, and wherein the resonant collector load circuit is configured to have reduced impedance at a harmonic of the local oscillator frequency.

16. The method of claim 14, wherein the resonant collector load circuit is configured to have a frequency response that minimizes collector load at a desired distance away from the frequency of interest.

17. The method of claim 14, further comprising configuring the resonant collector load circuit as an adjustable circuit having a frequency response that is changeable responsive to a frequency control signal, such that the radiofrequency receiver circuit is configurable for operation at different frequencies of interest.

18. The method of claim 14, wherein the resonant collector load circuit comprises at least one of a notch-filter circuit and a parallel resistor-inductor-capacitor circuit.

19. The method of claim 14, wherein including the at least one frequency-dependent circuit further comprises including a resonant input signal filter circuit for the input stage transistor.

20. The method of claim 19, further comprising configuring the resonant collector load circuit and the resonant input signal filter circuit as adjustable circuits whose frequency responses are adjustable for operating the radiofrequency receiver circuit at different frequencies of interest.

21. The method of claim 13, further comprising including a broadband input signal matching circuit in the radiofrequency receiver circuit that is configured to provide input matching across a range of frequencies of interest.

22. The method of claim 13, further comprising including an active mixer load in the mixer circuit to increase a voltage conversion gain of the radiofrequency receiver circuit.

23. The method of claim 13, wherein feeding back the mixer signal comprises capacitively coupling the mixer output signal to an emitter degeneration connection of an input stage transistor of the low-noise amplifier circuit.

24. The method of claim 23, further comprising coupling the emitter degeneration connection to signal ground through an inductive element.

25. A wireless communication device including a radiofrequency receiver circuit comprising:
a low-noise amplifier circuit configured to generate an amplified output signal responsive to a radiofrequency input signal, said low-noise amplifier circuit including at least one frequency-dependent circuit configured to decrease amplifier gain at frequencies away from a frequency of interest;
a mixer circuit configured to generate a mixer output signal responsive to the amplified output signal and one or more local oscillator signals; and
a feedback circuit configured to couple the mixer output signal to the low-noise amplifier circuit as a negative feedback signal.

26. The wireless communication device of claim 25, wherein the at least one frequency-dependent circuit comprises a resonant collector load circuit for an input stage transistor of the low-noise amplifier circuit.

27. The wireless communication device of claim 26, wherein the frequency of interest is a local oscillator frequency of the one or more local oscillator signals, and wherein the resonant collector load circuit is configured to have reduced impedance at a harmonic of the local oscillator frequency.

28. The wireless communication device of claim 26, wherein the resonant collector load circuit comprises an adjustable circuit having a frequency response that is changeable responsive to a frequency control signal, such that the radiofrequency receiver circuit is configurable for operation at different frequencies of interest.

29. The wireless communication device of claim 26, wherein the resonant collector load circuit is configured as an adjustable circuit having a changeable frequency response for operation at different frequencies of interest.

30. The wireless communication device of claim 25, wherein the at least one frequency-dependent circuit comprises a resonant input signal filter circuit for an input stage transistor of the low-noise amplifier circuit.

31. The wireless communication device of claim 30, wherein the resonant input signal filter circuit comprises an adjustable circuit whose frequency response is changeable responsive to a frequency control signal for operating the radiofrequency receiver circuit at different frequencies of interest.
